(19) United States
(12) Patent Application Publication
(10) Pub. No.: US 2025/0309701 A1
(43) Pub. Date: Oct. 2, 2025

(54) WIRELESS POWER TRANSMISSION SYSTEM

(71) Applicant: CANON KABUSHIKI KAISHA, Tokyo (JP)

(72) Inventor: TAKASHI YASUNO, Kanagawa (JP)

(21) Appl. No.: 19/091,500

(22) Filed: Mar. 26, 2025

(30) Foreign Application Priority Data
Mar. 28, 2024 (JP) 2024-053204

(51) Int. Cl. H02J 50/80; H02J 50/00

(52) U.S. Cl. CPC H02J 50/80; H02J 50/005

(57) ABSTRACT

A wireless power transmission system includes a power transmission coil and a power reception coil, wherein the power transmission coil has a structure in which a conductor is uniformly wound around an entire area in a direction in which the power transmission coil moves relative to the power reception coil, wherein the power transmission coil includes a first area where power in a first power value range is wirelessly transmitted and a second area where power in a second power value range is wirelessly transmitted, wherein a maximal value of the second power value range is smaller than that of the first power value range, and wherein a coupling coefficient between the power transmission coil and the power reception coil when the power reception coil is in the second area of the power transmission coil is smaller than that when the power reception coil is in the first area.

### BACKGROUND

### Field

The present disclosure relates to a wireless power transmission system.

### Description of the Related Art

In recent years, a wireless power transmission system for wirelessly supplying power to a moving object has been under research and development.

For example, Japanese Patent Application Laid-Open No. 2013-14056 discusses a printer for wirelessly supplying power to a slidable ink cartridge by using an elongated power transmission coil. Wireless power transmission eliminates the need of a power line that is worn by movement, making it possible to improve the product quality.

In an apparatus for wirelessly transmitting power, a load apparatus may use different power values. Because the voltage output by a wireless power transmission system depends on the power value used by the load apparatus, a high withstand voltage may be needed for semiconductors in the following constant-voltage circuit. This increases the circuit scale of a power reception apparatus.

### SUMMARY

The present disclosure is directed to preventing the increase of the output voltage in a case where the power value to be wirelessly transmitted differs depending on the area of a power transmission coil.

According to some embodiments, a wireless power transmission system includes a power transmission coil and a power reception coil disposed to face each other and configured to be relatively movable, wherein the power transmission coil has a structure in which a conductor is uniformly wound around an entire area in a direction in which the power transmission coil moves relative to the power reception coil, wherein the power transmission coil includes a first area where power in a first power value range is wirelessly transmitted and a second area where power in a second power value range is wirelessly transmitted, wherein a maximal value of the second power value range is smaller than a maximal value of the first power value range, and wherein a coupling coefficient between the power transmission coil and the power reception coil when the power reception coil is in the second area of the power transmission coil is smaller than a coupling coefficient between the power transmission coil and the power reception coil when the power reception coil is in the first area of the power transmission coil.

Further features of the present disclosure will become apparent from the following description of exemplary embodiments with reference to the attached drawings.

### BRIEF DESCRIPTION OF THE DRAWINGS

FIG. 1 illustrates an example configuration of a wireless power transmission system.

FIGS. 2A and 2B illustrate example configurations of coils.

FIG. 3 illustrates variations of the coupling coefficient between coils and the output voltage of a power reception circuit.

FIG. 4 illustrates a relation between the output power and the output voltage of the power reception circuit.

FIGS. 5A and 5B illustrate other example configurations of coils.

FIG. 6 illustrates other variations of the coupling coefficient between coils and the output voltage of the power reception circuit.

FIG. 7 illustrates another relation between the output power and the output voltage of the power reception circuit.

### DESCRIPTION OF THE EMBODIMENTS

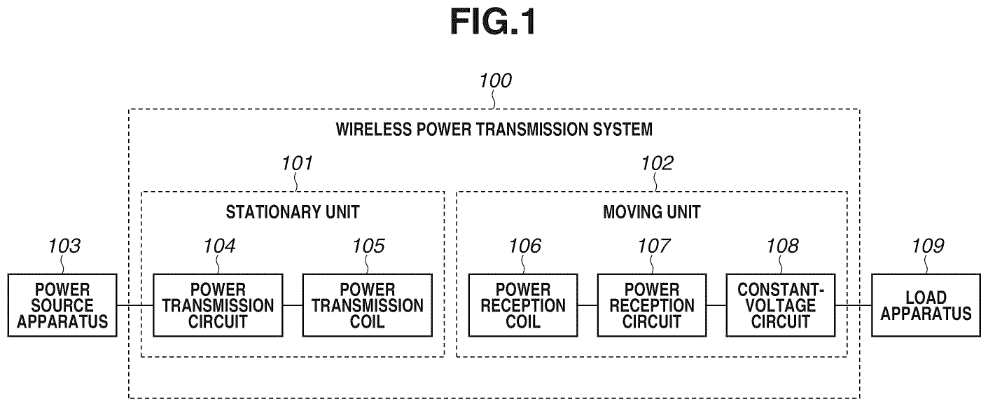

FIG. 1 illustrates an example configuration of a wireless power transmission system 100 according to a first exemplary embodiment. The wireless power transmission system 100 includes a stationary unit 101 and a moving unit 102.

The stationary unit 101 includes a power transmission circuit 104 and a power transmission coil 105. The moving unit 102 includes a power reception coil 106, a power reception circuit 107, and a constant-voltage circuit 108.

The power transmission circuit 104 converts the direct-current (DC) voltage supplied from a power source apparatus 103 into an alternating-current (AC) voltage and applies the AC voltage to the power transmission coil 105.

When the power transmission coil 105 is applied with the AC voltage, an AC current flows to generate a magnetic field.

The power reception coil 106 receives the magnetic field generated by the power transmission coil 105 to generate an AC current.

The power reception circuit 107 converts the AC current of the power reception coil 106 into a DC current and outputs the DC voltage to the constant-voltage circuit 108.

The constant-voltage circuit 108 converts the varying DC voltage of the power reception circuit 107 into a constant DC voltage and supplies the DC voltage to a load apparatus 109.

The load apparatus 109 has a plurality of functions, and a function to be activated depends on the position of the moving unit 102. The load apparatus 109 is supplied with the DC voltage from the constant-voltage circuit 108, and uses a different power value for each function.

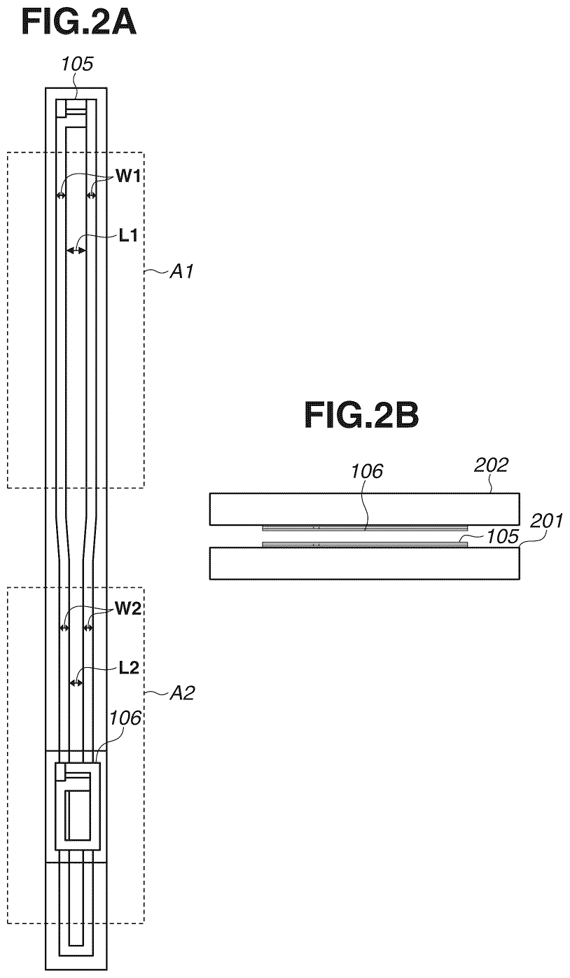

FIGS. 2A and 2B illustrate example configurations of the power transmission coil 105 and the power reception coil 106. FIG. 2A illustrates configurations of the power transmission coil 105 and the power reception coil 106 on the facing surface between the two coils.

The power reception coil 106 vertically translates while maintaining a constant distance to the power transmission coil 105. The power transmission coil 105 and the power reception coil 106 are movable relative to each other. The size of the power transmission coil 105 is sufficiently longer than the size of the power reception coil 106 in the moving direction of the power reception coil 106.

In this system, the load apparatus 109 uses different power values depending on the position of the moving unit 102. When the relevant position is in an area A1, the load apparatus 109 uses power in a high power value range. When the relevant position is in an area A2, the load apparatus 109 uses power in a low power value range.

The power transmission coil 105 includes the areas A1 and A2. The area A1 is an area where power in the high power value range is wirelessly transmitted. The area A2 is an area where power in the low power voltage range is wirelessly transmitted.

A conductor width W1 of the power transmission coil 105 in the area A1 and a conductor width W2 of the power transmission coil 105 in the area A2 are equivalent to each other. A separation distance L2 between the right and the left conductors of the power transmission coil 105 in the area A2 is shorter than a separation distance L1 between the right and the left conductors of the power transmission coil 105 in the area A1.

On the surface where the power transmission coil 105 faces the power reception coil 106, the separation distance L2 between a plurality of conductors of the power transmission coil 105 in the area A2 is shorter than the separation distance L1 between a plurality of conductors of the power transmission coil 105 in the area A1.

FIG. 2B illustrates a configuration viewed from the direction perpendicular to the facing surface between the power transmission coil 105 and the power reception coil 106. The power transmission coil 105 and the power reception coil 106 are disposed to face each other. Each of the power transmission coil 105 and the power reception coil 106 has a structure where a conductor is uniformly wound around an entire area in a direction in which the two coils face each other.

Magnetic substances 201 and 202 are disposed to increase the coupling coefficient K between the power reception coil 106 and the power transmission coil 105. The magnetic substances 201 and 202 having a uniform thickness are larger in size than the power transmission coil 105 and the power reception coil 106, respectively.

The power transmission coil 105 is in contact with the magnetic substance 201 on the side opposite to the side facing the power reception coil 106. The power reception coil 106 is in contact with the magnetic substance 202 on the side opposite to the side facing the power transmission coil 105.

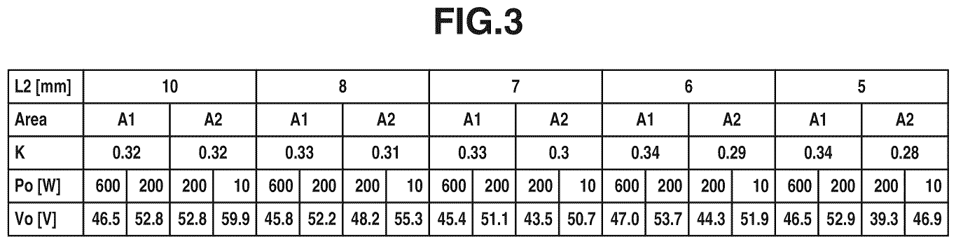

FIG. 3 illustrates variations of a coupling coefficient K between the power transmission coil 105 and the power reception coil 106 and an output voltage Vo of the power reception circuit 107. The output voltage Vo varies when the coupling coefficient K in the areas A1 and A2 changes depending on the separation distance L2 illustrated in FIG. 2A, and the range of a power value Po in the areas A1 and A2 changes from 600 W to 200 W and from 200 W to 10 W (watts), respectively.

The coupling coefficient K between the power transmission coil 105 and the power reception coil 106 when the power reception coil 106 is in the area A2 of the power transmission coil 105 is smaller than the coupling coefficient K between the power transmission coil 105 and the power reception coil 106 when the power reception coil 106 is in the area A1 of the power transmission coil 105.

When the power reception coil 106 is in the area A2 of the power transmission coil 105, the coupling coefficient K between the power transmission coil 105 and the power reception coil 106 decreases as the separation distance L2 between the plurality of conductors of the power transmission coil 105 in the area A2 decreases.

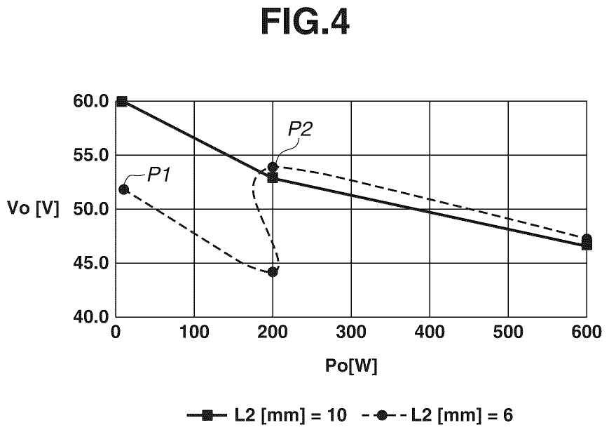

FIG. 4 illustrates a relation between the output power Po and the output voltage Vo of the power reception circuit 107 when the separation distance L2 in FIG. 3 is 6 mm and 10 mm (millimeters).

Reducing the separation distance L2 makes the coupling coefficient K between the power transmission coil 105 and the power reception coil 106 in the area A2 smaller than that in the area A1, making it possible to reduce the variation range of the output voltage Vo in the area A2.

To lower the withstand voltage of the semiconductor included in the constant-voltage circuit 108, desirably, the output voltage Vo (P1 illustrated in FIG. 4) for the power value 10 W in the area A2 is lower than the output voltage Vo (P2 illustrated in FIG. 4) for the power value 200 W in the area A1.

A similar effect is obtained in a case where the maximal value of the range of the power value Po in the area A2 is smaller than the maximal value of the range of the power value Po in the area A1.

According to the first exemplary embodiment, the conductor width W1 of the power transmission coil 105 in the area A1 and the conductor width W2 of the power transmission coil 105 in the area A2 are equivalent to each other. In this case, reducing the separation distance L2 in the area A2 makes the coupling coefficient K between the power transmission coil 105 and the power reception coil 106 in the area A2 smaller than that in the area A1, making it possible to reduce the range of the output voltage Vo in the area A2.

Making the thickness of the magnetic substance 201 in the area A2 smaller than the thickness of the magnetic substance 201 in the area A1 also enables making the coupling coefficient K between the power transmission coil 105 and the power reception coil 106 in the area A2 smaller than that in the area A1.

When the power reception coil 106 is in the area A2 of the power transmission coil 105, the coupling coefficient K between the power transmission coil 105 and the power reception coil 106 decreases as the thickness of the magnetic substance 201 in the area A2 decreases.

The configuration of the wireless power transmission system 100 according to a second exemplary embodiment is similar to that according to the first exemplary embodiment.

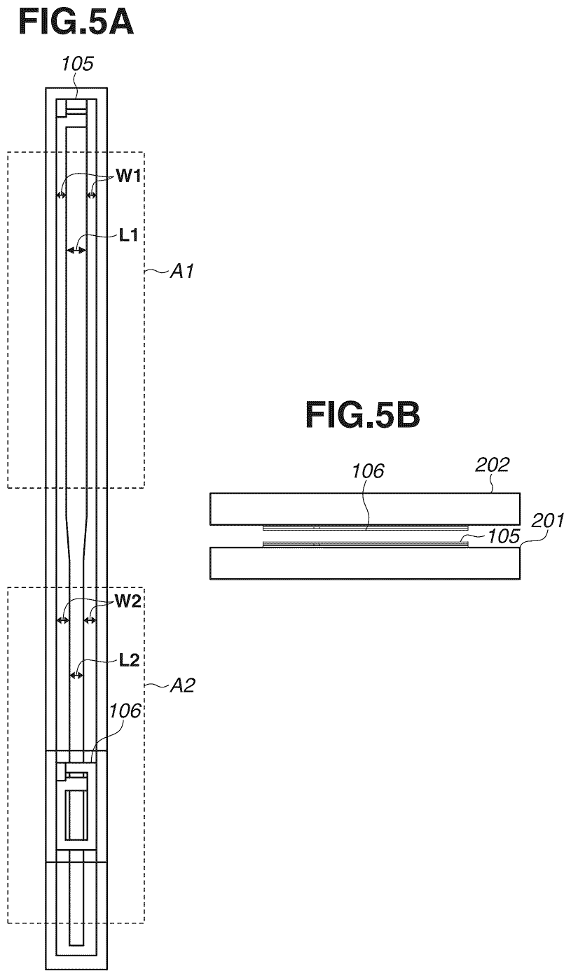

FIGS. 5A and 5B illustrate example configurations of the power transmission coil 105 and the power reception coil 106. FIG. 5A illustrates example configurations of the power transmission coil 105 and the power reception coil 106 on the facing surface between the two coils.

The power reception coil 106 vertically translates while maintaining a constant distance to the power transmission coil 105. The size of the power transmission coil 105 is sufficiently longer than the size of the power reception coil 106 in the moving direction of the power reception coil 106.

The load apparatus 109 uses different power values depending on the position of the moving unit 102. When the relevant position is in the area A1, the load apparatus 109 uses power in the high power value range. When the relevant position is in the area A2, the load apparatus 109 uses power in the low power value range.

The conductor width W2 of the power transmission coil 105 in the area A2 and the conductor width W1 of the power transmission coil 105 in the area A1 are different from each other. The separation distance L2 between the right and the left conductors of the power transmission coil 105 in the area A2 is shorter than the separation distance L1 between the right and the left conductors of the power transmission coil 105 in the area A1.

On the surface where the power transmission coil 105 faces the power reception coil 106, the separation distance L2 between the plurality of conductors of the power transmission coil 105 in the area A2 is shorter than the separation distance L1 between the plurality of conductors of the power transmission coil 105 in the area A1.

FIG. 5B illustrates an example configuration when viewed from the direction perpendicular to the facing surface between the power transmission coil 105 and the power reception coil 106. Each of the power transmission coil 105 and the power reception coil 106 has a structure in which a conductor is uniformly wound around an entire area in a direction in which the two coils face each other. The magnetic substances 201 and 202 are disposed to increase the coupling coefficient K between the power reception coil 106 and the power transmission coil 105. The magnetic substances 201 and 202 having a uniform thickness are larger in size than the power transmission coil 105 and the power reception coil 106, respectively.

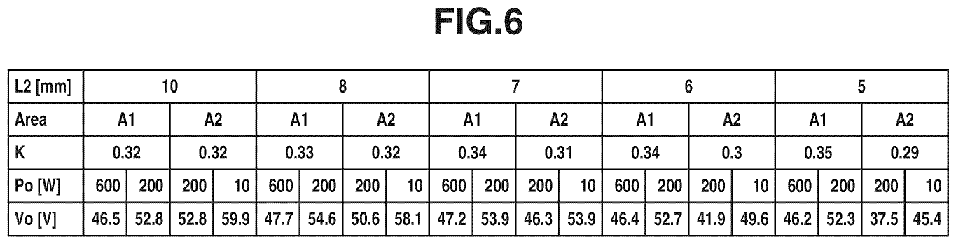

FIG. 6 illustrates variations of the coupling coefficient K between the power transmission coil 105 and the power reception coil 106 and an output voltage Vo of the power reception circuit 107. The output voltage Vo varies when the coupling coefficient K in the areas A1 and A2 changes depending on the separation distance L2 illustrated in FIG. 5A, and the range of a power value Po in the areas A1 and A2 changes from 600 W to 200 W and from 200 W to 10 W, respectively.

The coupling coefficient K between the power transmission coil 105 and the power reception coil 106 when the power reception coil 106 is in the area A2 of the power transmission coil 105 is smaller than the coupling coefficient K between the power transmission coil 105 and the power reception coil 106 when the power reception coil 106 is in the area A1 of the power transmission coil 105.

When the power reception coil 106 is in the area A2 of the power transmission coil 105, the coupling coefficient K between the power transmission coil 105 and the power reception coil 106 decreases as the separation distance L2 between the plurality of conductors of the power transmission coil 105 in the area A2 decreases.

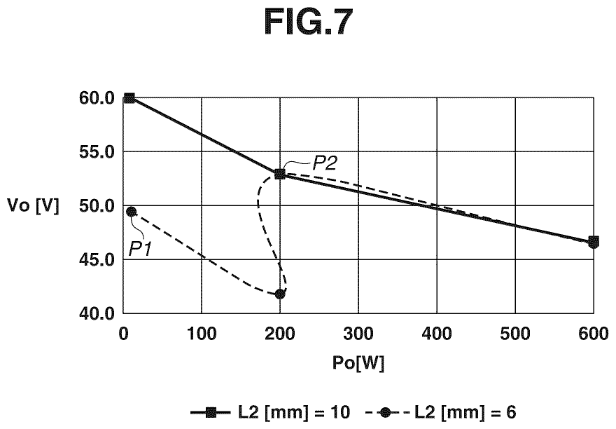

FIG. 7 illustrates a relation between the output power Po and the output voltage Vo of the power reception circuit 107 when the separation distance L2 in FIG. 3 is 6 mm and 10 mm. Reducing the separation distance L2 makes the coupling coefficient K between the power transmission coil 105 and the power reception coil 106 in the area A2 smaller than that in the area A1, making it possible to reduce the variation range of the output voltage Vo in the area A2.

To lower the withstand voltage of the semiconductor included in the constant-voltage circuit 108, desirably, the output voltage Vo (P1 illustrated in FIG. 7) for the power value 10 W in the area A2 is lower than the output voltage Vo (P2 illustrated in FIG. 7) for the power value 200 W in the area A1.

A similar effect is obtained in a case where the maximal value in the range of the power value Po in the area A2 is smaller than the maximal value in the range of the power value Po in the area A1.

According to the second exemplary embodiment, the conductor width W1 of the power transmission coil 105 in the area A1 and the conductor width W2 of the power transmission coil 105 in the area A2 are different from each other. In this case, reducing the separation distance L2 in the area A2 makes the coupling coefficient K between the power transmission coil 105 and the power reception coil 106 in the area A2 smaller than that in the area A1, making it possible to reduce the range of the output voltage Vo in the area A2.

Making the thickness of the magnetic substance 201 in the area A2 smaller than the thickness of the magnetic substance 201 in the area A1 enables making the coupling coefficient K between the power transmission coil 105 and the power reception coil 106 in the area A2 smaller than that in the area A1.

When the power reception coil 106 is in the area A2 of the power transmission coil 105, the coupling coefficient K between the power transmission coil 105 and the power reception coil 106 decreases as the thickness of the magnetic substance 201 in the area A2 decreases.

As described above, the first and the second exemplary embodiments enable preventing the increase of the output voltage Vo of the power reception circuit 107 even if the load apparatus 109 uses different power values Po depending on the position of the moving object of the power reception coil 106.

Each of the above-described exemplary embodiments is to be considered as illustrative in embodying the present disclosure, and is not to be interpreted as restrictive on the technical scope of the present disclosure. The present disclosure may be embodied in diverse forms without departing from the technical concepts or essential characteristics thereof.

The disclosure of the present exemplary embodiment includes the following configurations:

### (Configuration 1)

A wireless power transmission system includes a power transmission coil and a power reception coil disposed to face each other and configured to be relatively movable. The power transmission coil has a structure in which a conductor is uniformly wound around an entire area in a direction in which the power transmission coil moves relative to the power reception coil. The power transmission coil includes a first area where power in a first power value range is wirelessly transmitted, and a second area where power in a second power value range is wirelessly transmitted. The maximal value of the second power value range is smaller than a maximal value of the first power value range. A coupling coefficient between the power transmission coil and the power reception coil when the power reception coil is in the second area of the power transmission coil is smaller than a coupling coefficient between the power transmission coil and the power reception coil when the power reception coil is in the first area of the power transmission coil.

### (Configuration 2)

The wireless power transmission system according to configuration 1, wherein a size of the power transmission coil is longer than a size of the power reception coil in the direction in which the power transmission coil moves.

### (Configuration 3)

The wireless power transmission system according to configuration 1 or 2, wherein the power transmission coil is in contact with a magnetic substance on a side opposite to a side facing the power reception coil.

### (Configuration 4)

The wireless power transmission system according to any one of configurations 1 to 3, wherein on a facing surface where the power transmission coil faces the power reception coil, a separation distance between a plurality of conductors of the power transmission coil in the second area is shorter than a separation distance between a plurality of conductors of the power transmission coil in the first area.

### (Configuration 5)

The wireless power transmission system according to any one of configurations 1 to 4, wherein when the power reception coil is in the second area of the power transmission coil, the coupling coefficient between the power transmission coil and the power reception coil decreases as the separation distance between a plurality of conductors of the power transmission coil in the second area decreases.

### (Configuration 6)

The wireless power transmission system according to configuration 3, wherein the thickness of the magnetic substance in the second area is thinner than the thickness of the magnetic substance in the first area.

### (Configuration 7)

The wireless power transmission system according to configuration 3 or 6, wherein when the power reception coil is in the second area of the power transmission coil, the coupling coefficient between the power transmission coil and the power reception coil decreases with decreasing thickness of the magnetic substance in the second area.

### (Configuration 8)

The wireless power transmission system according to any one of configurations 1 to 7, wherein a conductor width of the power transmission coil in the first area and a conductor width of the power transmission coil in the second area are equivalent to each other.

### (Configuration 9)

The wireless power transmission system according to any one of configurations 1 to 7, wherein a conductor width of the power transmission coil in the first area and a conductor width of the power transmission coil in the second area are different from each other.

### (Configuration 10)

The wireless power transmission system according to any one of configurations 1 to 9, further includes a power transmission circuit configured to convert the DC voltage into an AC voltage and apply the AC voltage to the power transmission coil.

### (Configuration 11)

The wireless power transmission system according to configuration 10, further includes a power reception circuit configured to convert the AC current of the power reception coil into a DC current.

### (Configuration 12)

The wireless power transmission system according to configuration 11, further includes a constant-voltage circuit configured to convert the voltage of the power reception circuit into a constant DC voltage.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-053204, filed Mar. 28, 2024, which is hereby incorporated by reference herein in its entirety.

What is claimed is:

1. A wireless power transmission system comprising:
a power transmission coil and a power reception coil disposed to face each other and configured to be relatively movable,
wherein the power transmission coil has a structure in which a conductor is uniformly wound around an entire area in a direction in which the power transmission coil moves relative to the power reception coil,
wherein the power transmission coil includes a first area where power in a first power value range is wirelessly transmitted, and a second area where power in a second power value range is wirelessly transmitted,
wherein a maximal value of the second power value range is smaller than a maximal value of the first power value range, and
wherein a coupling coefficient between the power transmission coil and the power reception coil when the power reception coil is in the second area of the power transmission coil is smaller than a coupling coefficient between the power transmission coil and the power reception coil when the power reception coil is in the first area of the power transmission coil.

2. The wireless power transmission system according to claim 1, wherein a size of the power transmission coil is longer than a size of the power reception coil in the direction in which the power transmission coil moves.

3. The wireless power transmission system according to claim 1, wherein the power transmission coil is in contact with a magnetic substance on a side opposite to a side facing the power reception coil.

4. The wireless power transmission system according to claim 3, wherein a thickness of the magnetic substance in the second area is thinner than a thickness of the magnetic substance in the first area.

5. The wireless power transmission system according to claim 3, wherein, when the power reception coil is in the second area of the power transmission coil, the coupling coefficient between the power transmission coil and the power reception coil decreases as a thickness of the magnetic substance in the second area decreases.

6. The wireless power transmission system according to claim 1, wherein, on a facing surface where the power transmission coil faces the power reception coil, a separation distance between a plurality of conductors of the power transmission coil in the second area is shorter than a separation distance between a plurality of conductors of the power transmission coil in the first area.

7. The wireless power transmission system according to claim 1, wherein, when the power reception coil is in the second area of the power transmission coil, the coupling coefficient between the power transmission coil and the power reception coil decreases as a separation distance between a plurality of conductors of the power transmission coil in the second area decreases.

8. The wireless power transmission system according to claim 1, wherein a conductor width of the power transmission coil in the first area and a conductor width of the power transmission coil in the second area are equivalent to each other.

9. The wireless power transmission system according to claim 1, wherein a conductor width of the power transmission coil in the first area and a conductor width of the power transmission coil in the second area are different from each other.

10. The wireless power transmission system according to claim 1, further comprising a power transmission circuit configured to convert a direct-current (DC) voltage into an alternating-current (AC) voltage and apply the AC voltage to the power transmission coil.

11. The wireless power transmission system according to claim 10, further comprising a power reception circuit configured to convert an AC current of the power reception coil into a DC current.

12. The wireless power transmission system according to claim 11, further comprising a constant-voltage circuit configured to convert a voltage of the power reception circuit into a constant DC voltage.
